(19) United States
(12) Patent Application Publication
(10) Pub. No.: US 2013/0264915 A1
(43) Pub. Date: Oct. 10, 2013

(54) Magnetic Field Angle Measurement Apparatus, Rotation Angle Measurement Apparatus, and Rotation Machine, System, Vehicle, and Vehicle Drive Apparatus Each Using Same Rotation Angle Measurement Apparatus

(71) Applicants: Mutsumi Suzuki, Kodaira (JP); Katsuaki Fukatsu, Naka (JP); Takafumi Matsumura, Hitachinaka (JP)

(72) Inventors: Mutsumi Suzuki, Kodaira (JP); Katsuaki Fukatsu, Naka (JP); Takafumi Matsumura, Hitachinaka (JP)

(73) Assignee: HITACHI AUTOMOTIVE SYSTEMS, LTD., Hitachinaka-shi, Ibaraki (JP)

(21) Appl. No.: 13/992,935

(22) PCT Filed: Dec. 20, 2011
(86) PCT No.: PCT/JP2011/079432

§ 371 Date: Jun. 10, 2013

(30) Foreign Application Priority Data
Dec. 28, 2010 (JP) 2010-291545

(51) Int. Cl. G01B 7/30; H02K 11/00

(52) U.S. Cl. CPC G01B 7/30; H02K 11/0021
USPC 310/68 B; 324/207.21

(57) ABSTRACT

In a rotation angle measurement apparatus using a bridge configuration of a magneto-resistance element, a correct angle is not output when a fault occurs. For this reason, there is a problem in which an upper-layer system using the same is broken down. However, in order to solve this problem, there is provided a rotation angle measurement apparatus including a SIN bridge and a COS bridge each of which includes a magneto-resistance element and a detection unit, wherein the detection unit outputs an angle signal based on a signal output from a normal half bridge when a fault occurs in any one of respective half bridges of the COS bridge or the SIN bridge.

### TECHNICAL FIELD

The present invention relates to a magnetic field angle measurement apparatus including a magneto-resistance element (hereinafter, referred to as a MR element) and a rotation angle measurement apparatus using the same.

Further, in this specification, a position sensor indicates a rotation angle sensor for detecting a position (rotation angle) of a rotation body or a position sensor for a moving body that moves in a translational manner.

### BACKGROUND ART

In a position sensor or a rotation angle measurement sensor which measures a rotation angle or position of a rotation body, a magnetic field generator such as a magnet is attached to a rotation body and a magnetic field direction is measured by a magnetic field angle measurement sensor.

Incidentally, in this specification, the position sensor indicates a rotation angle sensor for detecting a position (rotation angle) of a rotation body or a position sensor for a moving body that moves in a translational manner.

As such a magnetic field angle measurement sensor, a sensor using a magneto-resistance element is known. In the magneto-resistance element, an electric resistance value changes in response to the direction or intensity of the magnetic field applied to the element.

As the magneto-resistance element (MR element), an anisotropic magneto-resistance element (hereinafter, referred to as an “AMR element”), a giant magneto-resistance element (hereinafter, referred to as a “GMR element”), a tunneling magneto-resistance element (hereinafter, referred to as a “TMR element”), or the like is known. Hereinafter, the outline of the related art will be described by exemplifying a magnetic field detection apparatus using a GMR element.

The basic configuration of the GMR element is illustrated in FIG. 2. The GMR element includes a first magnetic layer (a fixed magnetic layer or a pin magnetic layer) 13 and a second magnetic layer (a free magnetic layer) 11, and a non-magnetic layer (a spacer layer) 12 is interposed between both magnetic layers. When an external magnetic field 30 is applied to the GMR element, the magnetization direction of the fixed magnetic layer is fixed without any change, but a magnetization direction 20 of the free magnetic layer changes depending on the external magnetic field direction.

In this specification, an angle of a magnetization direction 22 of the fixed magnetic layer is referred to as a pin angle, and is indicated by θₚ.

When a voltage is applied to both ends of the GMR element, a current in response to the element resistance flows thereto. However, the magnitude of the element resistance changes depending on a difference Δθ=θ_{f}−θₚ between the magnetization direction (pin angle) θₚ of the fixed magnetic layer and the magnetization direction θ_{f} of the free magnetic layer. Thus, when the magnetization direction θₚ of the fixed magnetic layer is given, it is possible to detect the magnetization direction θ_{f} of the free magnetic layer, that is, the external magnetic field direction by measuring the resistance value of the GMR element using this characteristic.

The mechanism in which the resistance value of the GMR element changes by Δθ=θ_{f}−θₚ is as below.

The magnetization direction of the thin magnetic layer is involved with the spin direction of the electron inside the magnetic body. Thus, in a case of Δθ=0, the ratio of the electrons having the same spin direction is high in the electrons inside the free magnetic layer and the electrons inside the fixed magnetic layer. On the contrary, in a case of Δθ=180°, the ratio of the electrons having the opposite spin directions is high in the electrons inside both magnetic layers.

FIG. 3 schematically illustrates the cross-sections of the free magnetic layer 11, the spacer layer 12, and the fixed magnetic layer 13. The arrow in the free magnetic layer 11 and the fixed magnetic layer 13 schematically illustrates the spin direction of a plurality of electrons. FIG. 3(A) illustrates a case of Δθ=0, where the spin directions of the free magnetic layer 11 and the fixed magnetic layer 13 are equal to each other. FIG. 3(B) illustrates a case of Δθ=180°, where the spin directions of the free magnetic layer 11 and the fixed magnetic layer 13 are opposite to each other. In a case of FIG. 3(A) of θ=0, the electrons which come out from the fixed magnetic layer 13 and spin in the right direction are not substantially scattered inside the free magnetic layer 11 since a majority of electrons inside the free magnetic layer 11 have the same spin direction, and pass along a path such as an electron path 810. Meanwhile, in a case of FIG. 3(B) of Δθ=180°, the electrons which come out from the fixed magnetic layer 13 and spin in the right direction are strongly scattered inside the free magnetic layer 11 since a majority of electrons are in the opposite spin direction, and pass along a path such as an electron path 811. In this way, since the electron scattering amount increases in a case of Δθ=180°, the electric resistance increases.

In a middle case of Δθ=0 to 180°, the state becomes a middle state in FIGS. 3(A) and 3(B). It is known that the resistance value of the GMR element changes according to the following expression.

$$\begin{matrix}[ Expression 1 ] & \\ R = {R}_{0}^{′} + \frac{G}{2} ( 1 - cos Δ θ ) = {R}_{0} - \frac{G}{2} cos Δ θ & Expression 1\end{matrix}$$

G/R is called a GMR coefficient, and is several percentages to several tens of percentages.

In this way, since the current flow direction (that is, the electric resistance) can be controlled depending on the electron spin direction, the GMR element is also called a spin valve element.

Further, in a magnetic film (thin magnetic film) of which a film thickness is thin, a demagnetization coefficient in a direction perpendicular to a surface is extremely large, and hence a magnetization vector cannot rise in the perpendicular direction (film thickness direction), but lies in the surface. Since both the free magnetic layer 11 and the fixed magnetic layer 13 constituting the GMR element are sufficiently thin, the respective magnetization vectors lie in the surface.

In an application as a magnetic sensor, a Wheatstone bridge 60 is configured by using four GMR elements R₁(51-1) to R₄(51-4) as illustrated in FIG. 4. Here, the magnetization direction of the fixed magnetic layer of R₁(51-1) and R₃(51-3) is set as θₚ=0, and the magnetization direction of the fixed magnetic layer of R₂ and R₄ is set as θₚ=180°. Since the magnetization direction θ_{f} of the free magnetic layer is defined in the external magnetic field and the same in four GMR elements, a relation of Δθ₂=θ_{f}−θₚ₂=θ_{f}−θₚ₁−π=Δθ₁+π is established. Here, since Δθ₁ is based on θₚ=0, Δθ₁=θ is obtained.

$$\begin{matrix}[ Expression 2 ] & \\ {R}_{n} = {R}_{n 0} - \frac{G}{2} cos θ & Expression 2\end{matrix}$$

Thus, as understood from (Equation 1), the equation is established as above in R₁ and R₃ (n=1, 3)

$$\begin{matrix}[ Expression 3 ] & \\ {R}_{n} = {R}_{n 0} + \frac{G}{2} cos θ & Expression 3\end{matrix}$$

Then, the equation is established as above in R₂ and R₄ (n=2, 4).

When the excitation voltage e₀ is applied to the bridge circuit 60 of FIG. 4, the differential voltage ΔV=V_{c2}−V_{c1} between terminals V_{c1} and V_{c2} is obtained as below:

$$\begin{matrix}[ Expression 4 ] & \\ Δ V = \frac{{R}_{1} {R}_{3} - {R}_{2} {R}_{4}}{( {R}_{1} + {R}_{4} ) ( {R}_{2} + {R}_{3} )} {e}_{0} & Expression 4\end{matrix}$$

When (Equation 2) and (Equation 3) are applied thereto and it is assumed that Rₙ₀ is the same in n=1 to 4 to obtain R₀=Rₙ₀:

$$\begin{matrix}[ Expression 5 ] & \\ Δ {V}_{c} = \frac{- {e}_{0} G}{2 {R}_{0}} cos θ & Expression 5\end{matrix}$$

The equation is obtained as above. In this way, since the signal voltage Δv is proportional to cos θ, the magnetic field direction θ can be detected. Further, since the bridge circuit outputs a signal proportional to cos θ, the bridge circuit is called a COS bridge.

A bridge 61 will be considered in which the direction of the fixed magnetic layer is changed by 90° with respect to the COS bridge. That is, the bridge is configured by the GMR element having θₚ=90° and 270°. When the above-described calculation is performed, the signal voltage ΔVₛ (=Vₛ₂−Vₛ₁) is proportional to sine as below:

$$\begin{matrix}[ Expression 6 ] & \\ Δ {V}_{s} = \frac{{e}_{0} G}{2 {R}_{0}} sin θ & Expression 6\end{matrix}$$

Thus, the bridge 61 is called a SIN bridge. When the arc tangent of the ratio of two output signals of the COS bridge and the SIN bridge is calculated, the magnetic field vector direction θₘ (magnetic field angle) is obtained.

$$\begin{matrix}[ Expression 7 ] & \\ Arc Tan ( \frac{Δ {V}_{s}}{- Δ {V}_{c}} ) = Arc Tan ( \frac{sin θ}{cos θ} ) = θ & Expression 7\end{matrix}$$

In this way, there is a characteristic in which the magneto-resistance element directly detects the magnetic field direction.

In particular, in a rotation angle sensor used in an automobile, an industrial machine, and a robot, there is a need to avoid an accident in which an erroneous value is output as a sensor output value. A method of detecting a fault occurring in a rotation angle sensor is disclosed in, for example, PTL 1.

In PTL 1, it is determined that a failure occurs in a sensor when a sum (V₁+V₂) of two outputs V₁ and V₂ of the bridges exceeds a predetermined range, and an action is taken in which prevents erroneous angle information from being output from the sensor. In this way, the safety of the vehicle using the sensor can be improved.

### CITATION LIST

### Patent Literature

PTL 1: JP 2005-49097 A

### SUMMARY OF INVENTION

### Technical Problem

In recent years, there has been an attempt to electrically operate a vehicle like an electric vehicle.

Further, an electronic control also has been developed which is represented as “X-by-Wire” for operating a subject only by an electronic signal. For example, when an electric power steering control is exemplified, an command signal generated from a steering wheel by a driver is first converted into an electronic signal (angle information or the like) in a Steer-by-Wire system, and the result is transmitted to a steering control device, so that a steering drive motor is operated by a control in response to the electronic signal.

In this way, in the vehicle system which is operated by the electric control and the electronic control, for example, when a fault occurs in a rotation angle sensor for controlling a motor and a sensor operation is stopped, the motor cannot be operated. Accordingly, there is a problem in which the vehicle system itself cannot be operated.

In order to prevent such a problem, two rotation angle sensors are provided. Then, when a fault occurs in one sensor, the other sensor is operated. In this way, redundant sensors are used. However, when the redundant configuration is adopted, there is a problem in which cost increases and the reduction in the size of the system is interrupted.

Further, the vehicle represented by an automobile is exemplified, but even in the field of an industrial machine or a robot, the same problem arises in which the entire system is stopped when a failure occurs in the rotation angle sensor.

It is an object of the invention to provide a magnetic field angle measurement apparatus or a rotation angle measurement apparatus capable of outputting a measurement result for continuously performing an operation of a system even when a fault occurs in a sensor and contributing to reduction in the size of the system.

### Solution to Problem

The above-described problems can be solved by the following configuration.

A magnetic field angle measurement apparatus includes: a COS bridge and a SIN bridge including a magneto-resistance element and a detection unit detecting a magnetic field angle by receiving an output signal of the COS bridge and an output signal of the SIN bridge, in which the detection unit outputs an angle signal based on a signal output from a normal half bridge when a fault occurs in any one of respective half bridges of the COS bridge or the SIN bridge.

This specification includes the content of the specification and/or the drawings of Japanese Patent Application No. 2010-291545 that is claimed for priority of the application.

### Advantageous Effects of Invention

According to the invention, even when a fault occurs in the magnetic field angle measurement apparatus or the rotation angle measurement apparatus, the correct angle information can be continuously output.

Accordingly, even when a fault occurs in the magnetic field angle measurement apparatus or the rotation angle measurement apparatus, the upper-layer system such as a vehicle can be operated.

### BRIEF DESCRIPTION OF DRAWINGS

FIG. 1 is a diagram illustrating a configuration of a magnetic field angle measurement apparatus according to a first embodiment of the invention.

FIG. 2 is a diagram illustrating a configuration of a GMR element.

FIG. 3 is a diagram illustrating a mechanism of a change in the resistance of the GMR element.

FIG. 4 is a diagram illustrating a configuration of a bridge including a magneto-resistance element.

FIG. 5 is a diagram illustrating a configuration example of a MR bridge unit.

FIG. 6 is a diagram illustrating a wiring pattern of the GMR element.

FIG. 7 is a diagram illustrating a configuration of a redundant unit which is used in a second embodiment of the invention.

FIG. 8 is a diagram illustrating a configuration of a magnetic field angle measurement apparatus according to the second embodiment of the invention.

FIG. 9 is a diagram illustrating a configuration of a magnetic field angle measurement apparatus according to a third embodiment of the invention.

FIG. 10 is a table illustrating a switch selection combination of the third embodiment of the invention.

FIG. 11 is a diagram illustrating a configuration of a magnetic field angle measurement apparatus according to a fourth embodiment of the invention.

FIG. 12 is a diagram illustrating a configuration of a rotation angle measurement apparatus according to a fifth embodiment of the invention.

FIG. 13 is a diagram illustrating a configuration of a rotation machine according to a sixth embodiment of the invention.

FIG. 14 is a diagram illustrating a configuration of the rotation machine of the sixth embodiment of the invention.

FIG. 15 is a diagram illustrating a configuration of an EPS according to a seventh embodiment of the invention.

FIG. 16 is a diagram illustrating a configuration according to an eighth embodiment of the invention.

FIG. 17 is a diagram illustrating a vehicle drive apparatus according to a ninth embodiment of the invention.

FIG. 18 is a diagram illustrating a vehicle drive apparatus according to a tenth embodiment of the invention.

FIG. 19 is a diagram illustrating a configuration example of a data output signal of the invention.

FIG. 20 is a diagram illustrating an example of a package configuration of a magnetic field angle measurement apparatus of the invention.

### DESCRIPTION OF EMBODIMENTS

Hereinafter, embodiments of the invention will be described.

### First Embodiment

In a first embodiment, an example is illustrated in which a giant magneto-resistance element (GMR element) is used as a magneto-resistance element.

FIG. 1 is a configuration diagram of a magnetic field angle detection apparatus according to this embodiment.

The magnetic field angle detection apparatus includes a COS bridge 60, a SIN bridge 61, and a detection unit 302. The COS bridge 60 and the SIN bridge 61 are collectively referred to as a MR bridge unit 70. Here, the “MR” stands for the magneto-resistance element (Magneto-Resistance).

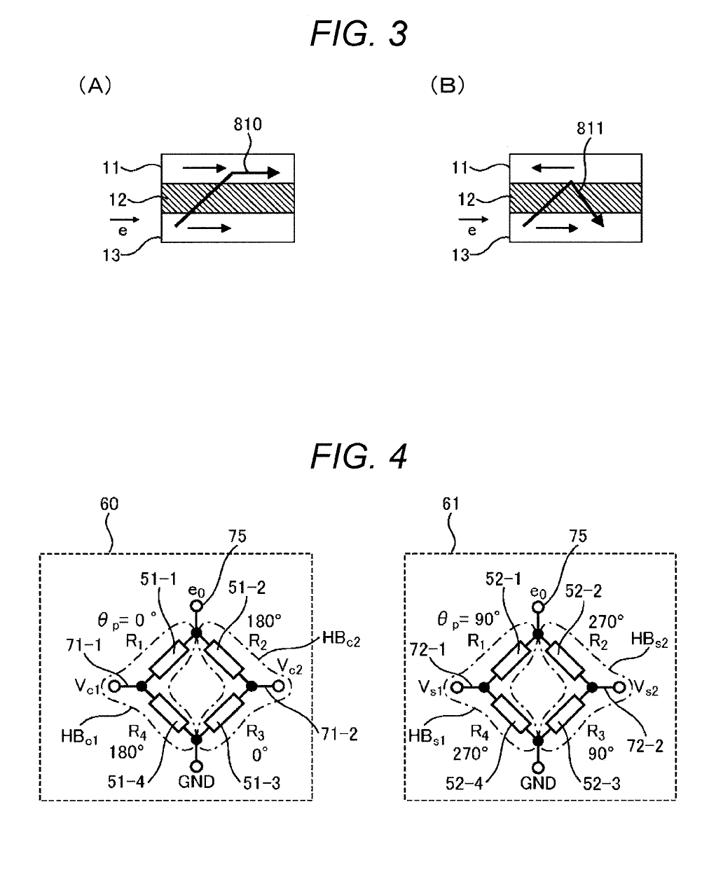

The COS bridge 60 includes four GMR elements 51, and the signal voltage (V_{c2}−V_{c1}) of the bridge is proportional to cosine cos θ of the magnetic field angle θ in a manner such that the spin direction (pin angle) of the fixed layer of the GMR element 51 is appropriately set as disclosed in FIG. 4. Further, the SIN bridge 61 also includes four GMR elements 52, and the signal voltage (Vₛ₂−Vₛ₁) of the bridge is proportional to sine sin θ of the magnetic field angle θ in a manner such that the pin angle of the GMR element 52 is appropriately set.

In other words, the state where the signal voltage (V_{c2}−V_{c1}) of the bridge is proportional to cosine cos θ of the magnetic field angle θ is defined by the COS bridge 60, and the state where the signal voltage (Vₛ₂−Vₛ₁) is proportional to sine sink) of the magnetic field angle θ is defined by the SIN bridge 61. At this time, the reference angle of the magnetic field angle θ is appropriately set so that two signals are respectively proportional to cos θ and sin θ.

Further, as described below in detail, in the magnetic field angle detection apparatus using an anisotropic magneto-resistance element (AMR element), the COS bridge and the SIN bridge are defined as below. The equation of effective magnetic field angle θ_{eff}=2θ is defined, the state where the signal voltage (V_{c2}−V_{c1}) of the bridge is proportional to cosine cos(θ_{eff}) of the equation of effective magnetic field angle θ_{eff}=2θ is defined by the COS bridge, and the state where the signal voltage (Vₛ₂−Vₛ₁) is proportional to sine sin(θ_{eff}) of the effective magnetic field angle θ_{eff} is defined by the SIN bridge. At this time, the reference angle of the magnetic field angle is appropriately selected so that two signals are proportional to cos(θ_{eff}) and sin(θ_{eff}). The case where the AMR element is used will be described in the following embodiments.

The detection unit 302 receives the signal voltages V_{c1}, V_{c2}, Vₛ₁, and Vₛ₂ of the respective bridges and obtains the magnetic field angle θ using these signals to output the result. Ina normal operation mode, the magnetic field angle is obtained by using the relation of (Equation 2) to (Equation 7).

As illustrated in FIG. 1, an excitation voltage e₀ is applied to the COS bridge 60 and the SIN bridge 61, and the other terminal is set to an earth potential (which is a ground potential and is indicated by “GND” in the drawing). This is the same wiring as that of the normal bridge. The excitation voltage e₀ is set to 5 V in this embodiment.

Further, in FIG. 1, the wiring between the MR bridge unit 70 and the detection unit 302 is not illustrated, but a power supply unit for supplying the excitation voltage e₀ is provided inside the detection unit 302. The earth potential is also supplied from the detection unit 302 to both bridges. Even in the other drawings of this specification, the wiring of the earth potential and the excitation potential between the MR bridge unit 70 and the detection unit 302 is not illustrated in the drawings, but the appropriate wiring is performed as described above.

Incidentally, the power supply unit which supplies the excitation voltage e₀ and the earth potential may be provided separately from the detection unit 302. Further, as the power supply unit which supplies the excitation voltage, a constant-current power supply may be used instead of a constant-voltage power supply.

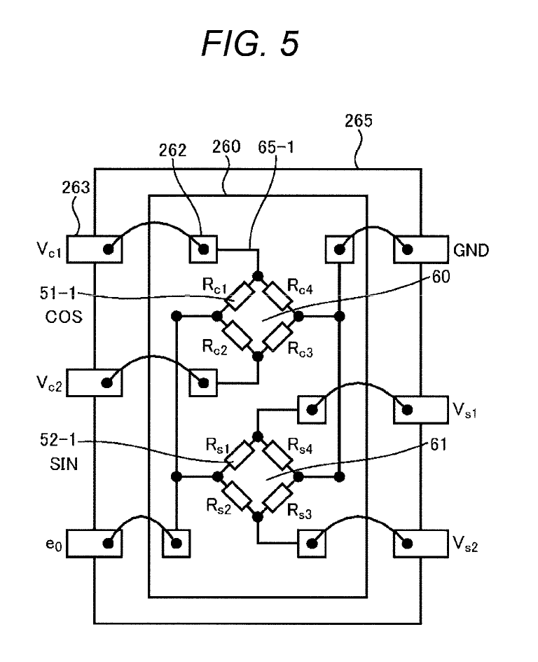

FIG. 5 illustrates a configuration of a sensor element package 265 which contains a GMR element bridge used in this embodiment. A wafer 260 provided with the GMR element 51 is mounted inside the sensor element package 265. The wafer 260 is provided with the COS bridge 60 and the SIN bridge 61. The respective bridges configure the Wheatstone bridge using four GMR elements 51 and 52. A pad 262 on the wafer 260 is connected to the corresponding terminal of the sensor element package 265 by wire bonding.

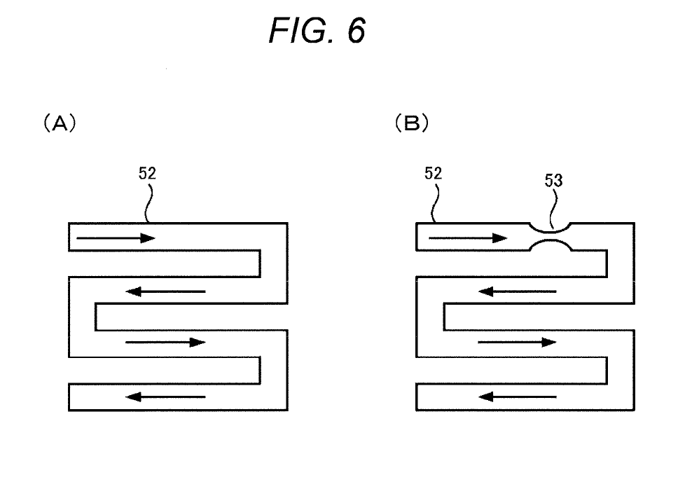

An example of the wiring pattern of the GMR element 52 is illustrated in FIG. 6(A). In the wiring pattern of the GMR element 52, a ratio (an aspect ratio) between the width and the length of the wiring is set so as to obtain a desired resistance value.

Next, an operation of the detection unit 302 when the GMR element 52 is normal will be described.

In a case where the GMR element 52 is normal, the following equation obtained from (Equation 5) and (Equation 6) when ΔV_{c21}=V_{c2}−V_{c1} and ΔVₛ₂₁=Vₛ₂−Vₛ₁:

$$\begin{matrix}[ Expression 8 ] & \\ Δ {V}_{O 21} = - \frac{- {e}_{0} G}{2 {R}_{0}} cos θ & Expression 8 \\ Δ {V}_{S 21} = - \frac{{e}_{0} G}{2 {R}_{0}} sin θ & \end{matrix}$$

Thus, the magnetic field angle θ is obtained by

[Expression 9]

θ=a tan 2(ΔVₛ₂₁,−ΔV_{c21}) Expression 9

The magnetic field angle θ is output as the angle output to the outside through an output terminal 90.

Here, θ=a tan 2(y, x) is a function of appropriately outputting a value in the range of θ=0 to 360° (or −180 to) 180° according to the positive or negative value of parameters x and y. For example, when x and y are all positive values, a tan 2(y, x)=ArcTan(y/x). When x and y are all negative values, a tan 2(y, x)=ArcTan(y/x)+180°.

In this specification, the terms of “fault” and “failure” are properly distinguished according to the following definitions.

The “fault” indicates a state where the characteristic inside the system exceeds the normal allowable value.

The “failure” indicates a state where the system cannot continuously perform the function thereof.

Here, the system indicates the magnetic field angle measurement apparatus or the rotation angle measurement apparatus or indicates the rotation machine, the vehicle drive apparatus, or the like using the same. Further, in this specification, the term of “breakdown” is also used as the same meaning as that of the “failure” which is defined as above.

Next, an operation when the fault occurs in the GMR element will be described.

The factor of causing the failure in the GMR element will be described. The factor of causing the failure in the GMR element includes a local increase in resistance. This is caused by the following reasons. Since the GMR element is formed as a thin film of about several nm (nano meter), the GMR element may be partially removed when an excessive current flows thereto.

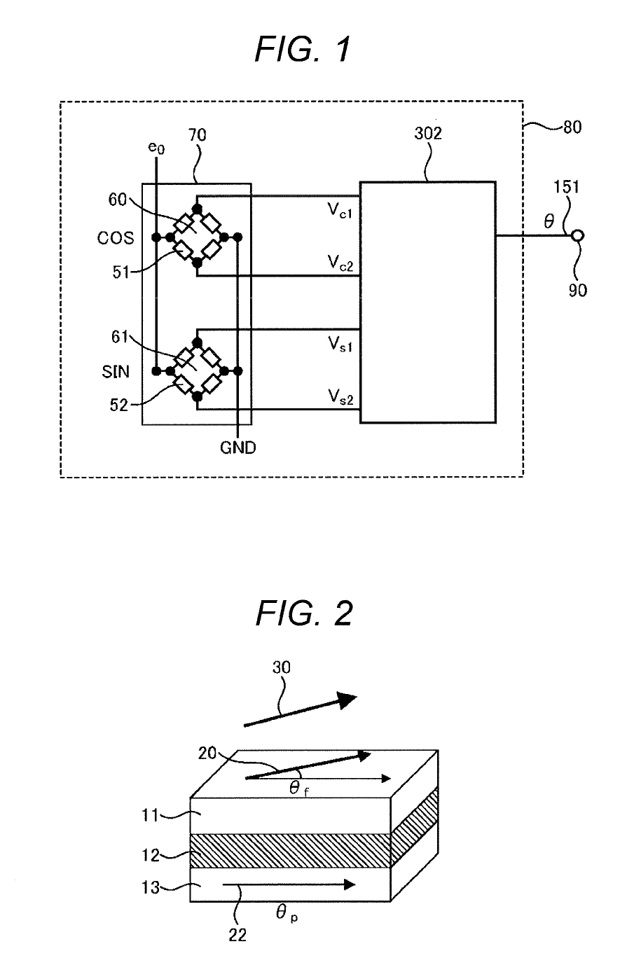

FIG. 6(B) schematically illustrates this state. FIG. 6 schematically illustrates one of four GMR elements 52 constituting the bridge. As described above with reference to FIG. 2, the wiring as the GMR element 52 includes a free magnetic layer 11, a spacer layer 12, and a fixed magnetic layer 13. FIG. 6(A) illustrates the normal GMR element 52, where the arrow indicates the current flow direction. FIG. 6(B) illustrates the GMR element 52 in which a part of the pattern is narrowed by the loss and a loss portion 53 (narrowed portion) has a high resistance in the current path.

As an example, a case will be considered in which the GMR element R₁ (52-1) in the SIN bridge 61 illustrated in FIG. 4 has the loss portion 53 in a part of the element as illustrated in FIG. 6(B). In this case, the resistance increases since the cross-sectional area of the wiring, which is narrowed by the loss, is reduced. That is, this is because the bulk resistance value locally increases in the narrowed portion (loss portion 53). On the contrary, as described above with reference to FIG. 3, the magnetoresistive effect is caused by the scattering in the boundary face between the free magnetic layer 11 and the spacer layer 12 and the boundary face between the fixed magnetic layer 13 and the spacer layer 12 in the entire wiring 52, and thus a change amount caused by the magnetoresistive effect is not substantially influenced even when the local bulk resistance increases. Thus, the resistance element which increases by the loss of the wiring is the element which does not depend on the magnetic field direction. Therefore, when the increase factor of the magnetic field direction independent term is formulated as b:

$$\begin{matrix}[ Expression 10 ] & \\ {R}_{1} = b * {R}_{10} - \frac{G}{2} cos {θ}_{x} , & Expression 10 \\ [ Expression 11 ] & \\ {R}_{n} = {R}_{n 0} - \frac{G}{2} cos {θ}_{x} , \\ ( n = 2 ∼ 4 ) & Expression 11\end{matrix}$$

As another failure factor, degradation in wire bonding may be exemplified. As an example, when a connection failure occurs due to degradation in the connection of the wire connecting the wafer pad 262 to a Vₛ₁ terminal 263 of FIG. 5, the signal voltage of the Vₛ₁ terminal of the sensor element package 265 is interrupted.

Here, the COS bridge 60 can be considered to be comprised of two half bridges, that is, a first half bridge HB_{c1} and a second half bridge HB_{c2}. Here, the first half bridge HB_{c1} includes a GMR element R₁ (51-1), a signal output V_{ci}, and a GMR element R₄ (51-4). The second half bridge HB_{c2} includes a GMR element R₂ (51-2), a signal output V_{c2}, and a GMR element R₃ (51-3).

In the same manner, the SIN bridge 61 can be considered to be comprised of two half bridges, that is, a first half bridge HBₛ₁ and a second half bridge HBₛ₂. Here, the first half bridge HBₛ₁ includes a GMR element R₁ (52-1), a signal output Vₛ₁, and a GMR element R₄ (52-4). The second half bridge HB_{c2} includes a GMR element R₂ (52-2), a signal output Vₛ₂, and a GMR element R₃ (52-3).

According to the invention, when the fault occurs in any one of two half bridges HBₛ₁ and HBₛ₂ constituting the SIN bridge 61 as described above, the magnetic field angle θ is obtained by using the signal of the normal half bridge. Specifically, when the fault occurs in the half bridge HBₛ₁, the magnetic field angle is obtained by using the output signal Vₛ₂ of the normal half bridge HBₛ₂.

In the same manner, when the fault occurs in one of two half bridges HB_{c1} and HB_{c2} constituting the COS bridge 60, the magnetic field angle is obtained by using the output signal of the normal half bridge.

This will be specifically described as below. When the difference between the voltage Vₛ₂ output from the half bridge HBₛ₂ constituting the GMR elements Rₛ₃ and Rₛ₄ and the voltage (hereinafter, referred to as the “middle voltage Vₘ”) of ½ of the excitation voltage e₀ is obtained and the value twice the difference is Δvₛ₂ₘ, the following is obtained:

$$\begin{matrix}[ Expression 12 ] & \\ \begin{matrix}Δ {V}_{S 2 m} = 2 ( {V}_{S 2} - {V}_{m} ) \\ = 2 ( \frac{{R}_{S 3} {e}_{0}}{{R}_{S 4} + {R}_{S 3}} - \frac{{e}_{0}}{2} ) \\ = \frac{{R}_{S 3} - {R}_{S 4}}{{R}_{S 4} + {R}_{S 3}} {e}_{0} \\ = \frac{{e}_{0} G}{2 {R}_{0}} sin θ\end{matrix} & Expression 12\end{matrix}$$

That is, as understood from the comparison with (Equation 8), Δvₛ₂ₘ becomes equal to the output signal Δvₛ₂₁ of the normal SIN bridge 61. Thus, the correct magnetic field angle θ is obtained as follows.

[Expression 13]

θ=a tan 2(ΔVₛ₂ₘ,−ΔVₒ₂₁) Expression 13

The magnetic field angle θ which is obtained in this way is output from a detector. Accordingly, a detection unit 302 of a magnetic field angle measurement apparatus 80 of the invention can be continuously output the correct magnetic field angle θ even when the fault occurs in the GMR element. Thus, an upper-layer system equipped with a magnetic field angle measurement apparatus can continue the operation.

In the description above, an example has been described in which the fault occurs in the half bridge HBₛ₁ including the GMR elements Rₛ₁ and Rₛ₄. When the fault occurs in the half bridge HBₛ₂ including the GMR elements Rₛ₂ and Rₛ₃, the magnetic field angle θ may be calculated by the following equation.

$$\begin{matrix}[ Expression 14 ] & \\ Δ {V}_{S 1 m} = - 2 ( {V}_{S 1} - {V}_{m} ) = \frac{{e}_{0} G}{2 {R}_{0}} sin θ & Expression 14 \\ [ Expression 15 ] & \\ θ = atan 2 ( Δ {V}_{s 1 {m}^{′}} - Δ {V}_{c 21} ) & Expression 15\end{matrix}$$

Further, even when the fault occurs in the GMR element of the COS bridge 60, the correct magnetic field angle θ is obtained in the same manner.

As described above, the operation state of the magnetic field angle measurement apparatus 80 which calculates the magnetic field angle by using the output signal of the normal half bridge is referred to as the “backup operation mode”. On the contrary, the operation state in which the magnetic field angle is calculated by using the signals ΔV_{c21} and ΔVₛ₂₁ without any fault in the COS bridge 60 and the SIN bridge 61 is referred to as the “normal operation mode”.

In the backup operation mode, as understood from (Equation 12), the measurement value Vₛ₂ is multiplied by a factor of two. Thus, since the noise included in the measurement value also becomes twice, the S/N ratio of the measurement value decreases compared to the normal operation mode. For this reason, there is a case in which the measurement precision of the magnetic field angle θ is slightly reduced compared to the normal operation mode. In this way, the measurement precision may be degraded in the backup operation mode, but the correct magnetic field angle θ is output.

Next, (1) a method of detecting a fault in the GMR element and (2) a method of identifying a fault in any half bridge will be described sequentially.

First, as in (Equation 12), the amount obtained by 2 times or −2 times the difference signal between the middle voltage Vₘ and the output voltages V_{c1}, V_{c2}, Vₛ₁, and Vₛ₂ of the respective half bridges is defined as below.

$$\begin{matrix}[ Expression 16 ] & \\ Δ {V}_{C 1 m} = - 2 ( {V}_{C 1} - {V}_{m} ) = \frac{{e}_{0} G}{2 {R}_{0}} cos θ & Expression 16 \\ Δ {V}_{C 2 m} = + 2 ( {V}_{C 2} - {V}_{m} ) = - \frac{{e}_{0} G}{2 {R}_{0}} cos θ & \\ Δ {V}_{S 1 m} = - 2 ( {V}_{S 1} - {V}_{m} ) = \frac{{e}_{0} G}{2 {R}_{0}} sin θ & \\ Δ {V}_{S 2 m} = + 2 ( {V}_{S 2} - {V}_{m} ) = \frac{{e}_{0} G}{2 {R}_{0}} sin θ & \end{matrix}$$

Furthermore, as understood from (Equation 12), the final equal sign in each equation of (Equation 16) is established only when the respective half bridges are normal.

The amount of (Equation 16) is defined by appropriately setting the polarity of the coefficient±2 so that each value becomes equal to the value of the differential signal ΔV_{c21} or ΔVₛ₂₁ in the normal state.

As understood from (Equation 16), ΔV_{c1m}=ΔV_{c2m} and ΔVₛ₁ₘ=ΔVₛ₂ₘ are established in the normal state. Thus, when ΔV_{c1m} is not equal to ΔV_{c2m}, t is understood that the fault occurs in the COS bridge 60. Similarly, when ΔVₛ₁ₘ is not equal to ΔVₛ₂ₘ, it is understood that the fault occurs in the SIN bridge 61.

In this way, it is possible to detect whether the fault occurs in the COS bridge 60 or the fault occurs in the SIN bridge 61.

Next, when a fault occurs in a half bridge, a process of identifying the half bridge constituting the bridge, in which the fault is occurred, will be described. That is, this is a process of identifying the normal half bridge. Here, as an example, a case will be supposed in which the fault occurs in the half bridge HBₛ₁ including the GMR elements Rₛ₁ and Rₛ₄. Even when the fault occurs in the other place, it is obvious that the fault position can be identified according to the same procedure.

When the identical equation of the trigonometrical function “(cos θ)²+(sin θ)²=1” is taken into consideration, the following relation is established from (Equation 8) and (Equation 16) during the normal operation.

$$\begin{matrix}[ Expression 17 ] & \\ {( Δ {V}_{S 1 m} )}^{2} = {( \frac{{e}_{0} G}{2 {R}_{0}} )}^{2} - {( Δ {V}_{C 21} )}^{2} & Expression 17 \\ {( Δ {V}_{S 2 m} )}^{2} = {( \frac{{e}_{0} G}{2 {R}_{0}} )}^{2} - {( Δ {V}_{C 21} )}^{2} & \end{matrix}$$

(Equation 17) is established only when the half bridge is normally operated. Thus, it is possible to identify that the fault occurs in the half bridge which does not satisfy the relation equation (Equation 17).

In practice, the determination is made as below to exclude the influence of the measurement noise or the like. First, the following residual amount is calculated:

$$\begin{matrix}[ Expression 18 ] & \\ {Δ}_{Res} ( j ) = {( \frac{{e}_{0} G}{2 {R}_{0}} )}^{2} - \{ {( Δ {V}_{C 21} )}^{2} + {( Δ {V}_{Sjm} )}^{2} \} & Expression 18\end{matrix}$$

Here, j=1 or 2, and Δ_{Res} (1) and Δ_{Res} (2) are obtained in response to the signals ΔVₛ₁ₘ and Δvₛ₂ₘ of two half bridge signals constituting the SIN bridge 61. The residual amount Δ_{Res} (j) is obtained by subtracting the sum of the square of the signal voltage (Δvₛ₂ₘ) of the normal bridge and the square of (Δv_{c21}) as twice the difference between the middle voltage Vₘ and the signal voltage of the half bridge of the other bridge from a constant value. The fault occurring place is determined based on whether the absolute value of the residual amount is large.

In this way, since it is possible to identify the fault in the half bridge HBₛ₁ including Rₛ₁ and R₅₄, ΔVₛ₂ₘ may be calculated by using the output signal Vₛ₂ of the normal half bridge HBₛ₂, and the magnetic field angle θ may be calculated by (Equation 13). In this way, the correct magnetic field angle is calculated.

### Second Embodiment

In a second embodiment of the invention, an example of a desirable circuit configuration of identifying a fault position and performing a redundant operation will be described.

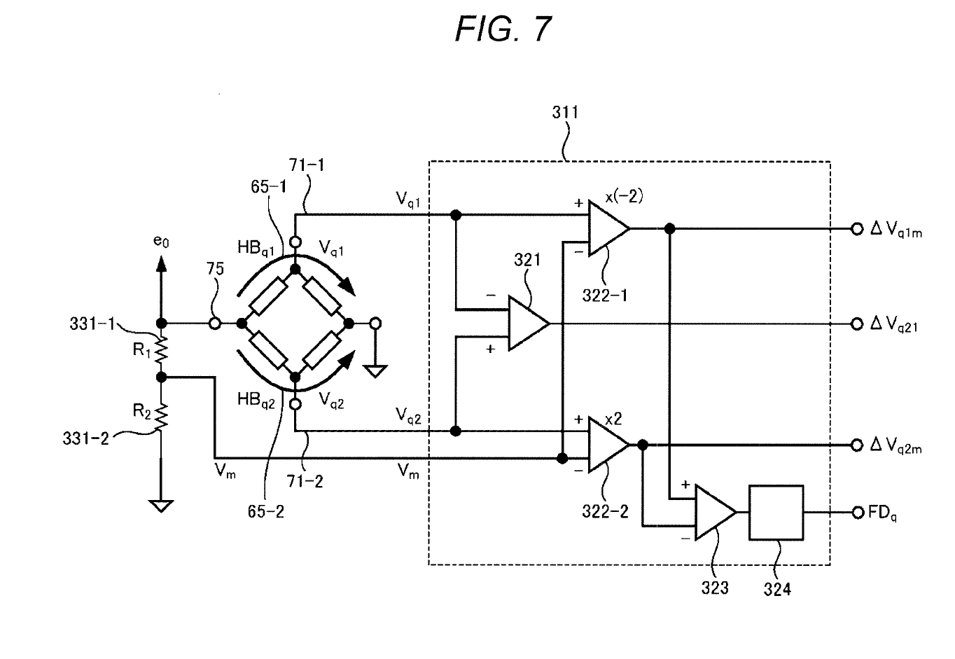

In the magnetic field angle detection apparatus of this embodiment, a redundant unit 311 is provided inside the detection unit 302. The configuration of the redundant unit 311 is illustrated in FIG. 7.

The redundant unit 311 receives the following signals as inputs: an output signal V_{q1} of a first half bridge 65-1 (HB_{q1}) an output signal V_{q2} of a second half bridge 65-2 (HB_{q2}), and the middle voltage Vₘ. Here, q=c or s, and the subscript characters respectively correspond to the COS bridge 60 and the SIN bridge 61. Hereinafter, the subscript character “q” is used as this meaning.

The middle voltage Vₘ is equal to e₀/2 as ½ of the excitation voltage e₀.

It is preferable that the circuit for generating the middle voltage Vₘ be a circuit as a ratiometric circuit based on the excitation voltage e₀. The ratiometric circuit indicates a circuit in which the generated voltage Vₘ is maintained at a constant ratio of e₀ even when the excitation voltage e₀ changes. The advantageous effect in which the Vₘ generation circuit is configured as the ratiometric circuit will be described below.

In this embodiment, the middle voltage Vₘ is generated by dividing the excitation voltage e₀ by the resistances R₁ (331-1) and R₂ (331-2). The resistances R₁ (331-1) and R₂ (331-2) have the same resistance value. Since the ratiometric circuit is configured in this way, the middle voltage Vₘ is maintained at ½ of e₀ even when the excitation voltage e₀ changes.

The circuit (in FIG. 7, the resistances R₁ and R₂ (331-1 and 331-2)) for generating the middle voltage Vₘ may be provided in the detection unit 302. Alternatively, when the power supply unit for generating the excitation voltage e₀ is provided separately from the detection unit 302, the middle voltage generation circuit may be provided in the power supply unit.

When these signals are input, the redundant unit 311 outputs output signals ΔV_{q21}, ΔV_{q1m}, and ΔV_{q2m} and a fault detection signal FD_{q}. The output signals ΔV_{q21} indicates the amount defined by (Equation 8), and the output signals ΔV_{q1m} and ΔV_{q2m} are the amounts defined by (Equation 16).

Next, the internal configuration of the redundant unit 311 will be described.

Through the differential amplification of two half bridge output signals, ΔV_{q21}=(V_{q2}−V_{q1}) is output. This is a signal which is used during the normal operation.

The first half bridge signal V_{q1} is amplified (−2) times by the differential amplification and the inverse amplification with the middle voltage Vₘ. In this way, ΔV_{q1m}=−2 (V_{q1}−Vₘ) is obtained. The second half bridge signal V_{q2} is amplified (+2) times by the differential amplification and the non-inverse amplification with the middle voltage Vₘ. In this way, ΔV_{q2m}=2 (V_{q2}−Vₘ) is obtained.

The fault detection signal FD_{q} is generated by inputting the differential output between ΔV_{g1m} and ΔV_{q2m} to a fault determination unit 324. Since (ΔV_{q1m}−ΔV_{q2m}) becomes zero during the normal operation, the fault detection signal is generated by the comparator circuit of the fault determination unit when the value exceeds the threshold value.

In the configuration of the redundant unit 311 of this embodiment, there are two points as follows.

First, the differential signal between the middle voltage Vₘ and the output signal of the half bridge is amplified.

In particular, since the middle voltage Vₘ generation circuit is configured as the ratiometric circuit as described above, the ratio between e₀ and Vₘ is maintained at a constant value even when the excitation voltage e₀ changes. As understood from (Equation 8) and (Equation 16), each of the signals ΔV_{q21}, ΔV_{q1m}, and ΔV_{q2m} is proportional to the excitation voltage e₀. As illustrated in (Equation 13), since the ratio of the signals is obtained when calculating the magnetic field angle θ, the value of the magnetic field angle θ is not influenced even when the excitation voltage e₀ changes. In this way, the differential signal between the middle voltage Vₘ and the output signal of the half bridge is amplified. Accordingly, there is an advantageous effect that the influence on the output signal is reduced even when the excitation voltage changes.

Second, the polarity of the amplification of the differential signal between the half bridge output signal and the middle voltage is changed. The inverse amplification is performed at one side, and the non-inverse amplification is performed at the other side. Accordingly, as understood from (Equation 16) and (Equation 8), ΔV_{q21}, ΔV_{g1m}, and ΔV_{q2m} are given as the same value during the normal operation, and thus the signal process of the detection unit 302 is simplified.

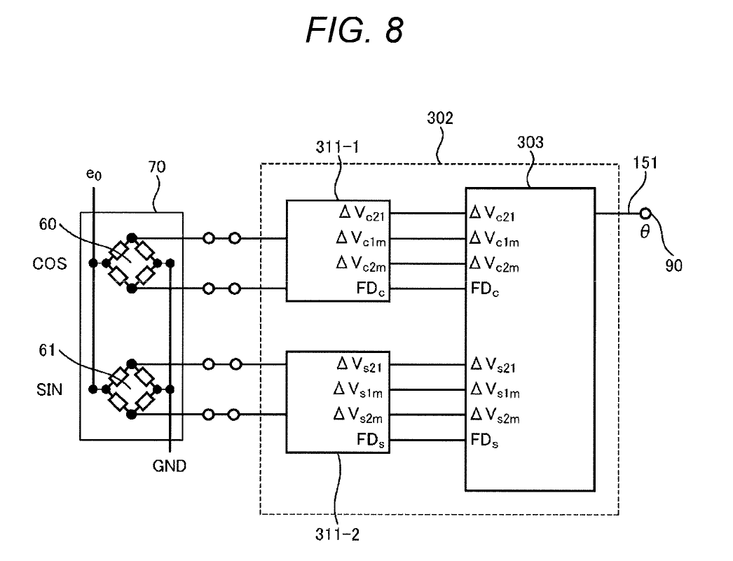

The configuration of the detection unit 302 of the second embodiment will be described with reference to FIG. 8.

The detection unit 302 includes a redundant unit 311-1 which inputs the output signal of the COS bridge 60 and a redundant unit 311-2 which inputs the output signal of the SIN bridge 61. The output signals of the respective redundant units are input to a signal processing unit 303. In this embodiment, a microcomputer is used as the signal processing unit 303, but the invention is not limited thereto.

The signals input to the signal processing unit 303 include ΔV_{c21}, ΔV_{c1m}, ΔV_{c2m}, FD_{c}, ΔVₛ₂₁, ΔVₛ₁ₘ, ΔVₛ₂ₘ, and FDₛ. Thus, the fault position is identified by the same method as that of the first embodiment using these signals, and the correct magnetic field angle θ can be output even when the fault occurs.

As described above, a case has been described in which the fault occurs in any one of the COS bridge 60 and the SIN bridge 61.

Next, a case will be described in which the fault occurs in both the COS bridge 60 and the SIN bridge 61. In a case where one half bridge is normal in each of the COS bridge 60 and the SIN bridge 61, the correct magnetic field angle θ can be output by the following method.

In this case, the respective fault detection signals FD_{c} and FDₛ of the COS bridge 60 and the SIN bridge 61 are generated, and thus the occurrence of the fault can be detected by two bridges. In this case, the correct half bridge of each of the bridges 60 and 61 is identified, and the correct magnetic field angle θ is obtained as described below.

[Expression 19]

θ=a tan 2(ΔVₛⱼ₀ₘ,−ΔV_{c10m}) Expression 19

Here, the correct half bridge in the COS bridge is i₀ (=1 or 2), and the correct half bridge in the SIN bridge is j₀ (=1 or 2).

Next, a process of identifying the correct half bridge will be described. First, the following four amounts are obtained.

$$\begin{matrix}[ Expression 20 ] & \\ {Δ}_{Res} 2 ( i , j ) = {( \frac{{e}_{0} G}{2 {R}_{0}} )}^{2} - \{ {( Δ {V}_{Cim} )}^{2} + {( Δ {V}_{Sjm} )}^{2} \} & Expression 20\end{matrix}$$

Here, i and j are 1 or 2, and are numbers corresponding to the half bridges HB_{c1} and HBₛ₁ or HB_{c2} and HB₅₂. Since (Equation 20) is obtained for all combinations of (i, j), Δ_{Res}2 (i, j) is calculated for four cases. In the combination of the normal half bridges of four half bridges, (Equation 20) becomes zero according to the relation of “(cos θ)²+(sin θ)²=1”. In practice, a noise in signals should be considered; therefore, the combination (i₀, j₀) in which the amount Δ_{Res}2 (i, j) defined by (Equation 20) becomes below a certain threshold value is sought and identified.

When the process of identifying the correct half bridge is completed, the correct angle is obtained by (Equation 19).

### Third Embodiment

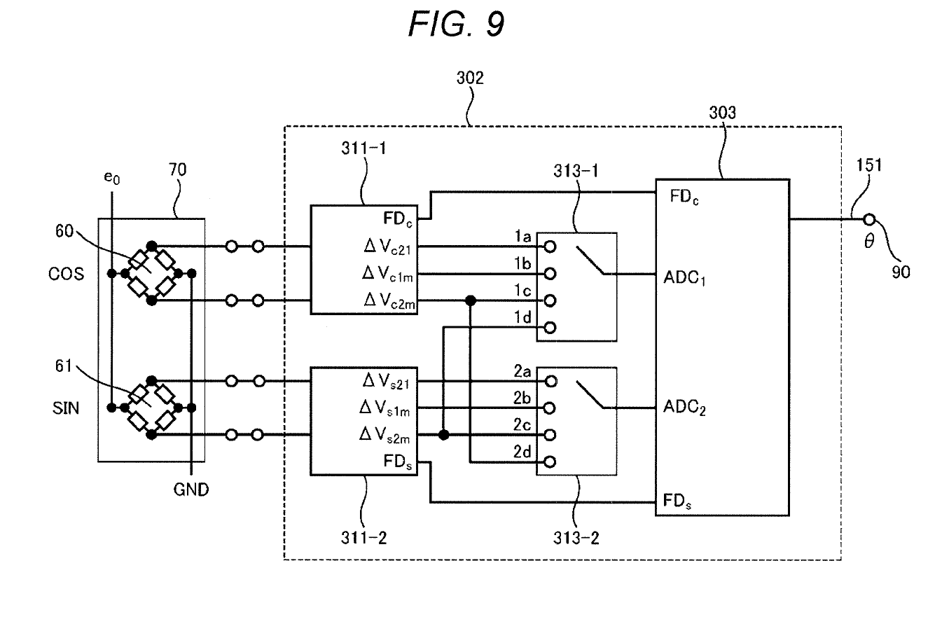

The magnetic field angle detection apparatus of a third embodiment of the invention will be described with reference to FIG. 9.

FIG. 9 illustrates a configuration of a detector of this embodiment. The output signals of the redundant unit 311-1 and the redundant unit 311-2 are respectively input to the selection switches 313-1 (SW1) and 313-2 (SW2). Accordingly, the number of the analog signal input terminals of the signal processing unit 303 may be decreased into two. Since the analog input terminal uses an analog-digital converter (hereinafter, referred to as an ADC), the analog input terminal is expensive compared to the logic signal input terminal, and hence it is desirable to decrease the number of the analog signal input terminals.

A selection state of a selection switch 313 of this embodiment will be described with reference to FIG. 10.

First, in a normal operation state, a selection switch SW1 (313-1) is connected to a position 1a, and a selection switch SW2 (313-2) is connected to a position 2a. In this way, since ΔV_{c21} and ΔVₛ₂₁ are input to the signal processing unit 303, the magnetic field angle θ is obtained according to (Equation 9), and is output as the magnetic field angle signal θ. The output magnetic field angle signal may be any one of the digital signal and the analog signal.

Next, FIG. 10(A) illustrates an operation of the selection switch 313 when the fault occurs in the SIN bridge 61.

When the fault occurs in the SIN bridge 61, the fault detection signal FDₛ is effective, and hence it is possible to detect a state where the fault occurs in the SIN bridge 61. Then, as illustrated in (ii) of FIG. 10(A), the selection switch SW1(313-1) is set to 1d and the selection switch SW2(313-2) is set to 2b. In this way, since ΔVₛ₂ₘ, and ΔVₛ₁ₘ are input to the signal processing unit 303, the half bridge in which the fault occurs is identified by using (Equation 17). Then, the selection switch 313 is set to the position of (iii) or (iv) of FIG. 10(A), and the backup operation is performed. The selection of (iii) or (iv) is performed so that the signal of the normal half bridge is input to the signal processing unit 303 in response to the result of identifying the fault occurring place. In this way, the correct magnetic field angle is output based on (Equation 13) or (Equation 15).

When the fault occurs in the COS bridge 60, the selection switch 313 is selected according to FIG. 10(B).

Finally, a case will be described in which the fault occurs in both the COS bridge 60 and the SIN bridge 61. In this case, the selection switch 313 is selected according to FIG. 10(C).

Next, a process in a case where the fault detection signals FD_{c} and FDₛ are generated from the COS bridge 60 and the SIN bridge 61 will be described.

In this case, the selection switch 313 is switched according to FIG. 10(C). In each of four steps, that is, steps (ii) to (v) of FIG. 10(c), the residual amount Δᵣₑₛ2 (i, j) defined by (Equation 20) is calculated, and the normal half bridges in the COS bridge and the SIN bridge are respectively found. Then, when the normal combination is found, any one of the steps (ii) to (v) is set, and the correct magnetic field angle θ is calculated by (Equation 19).

### Fourth Embodiment

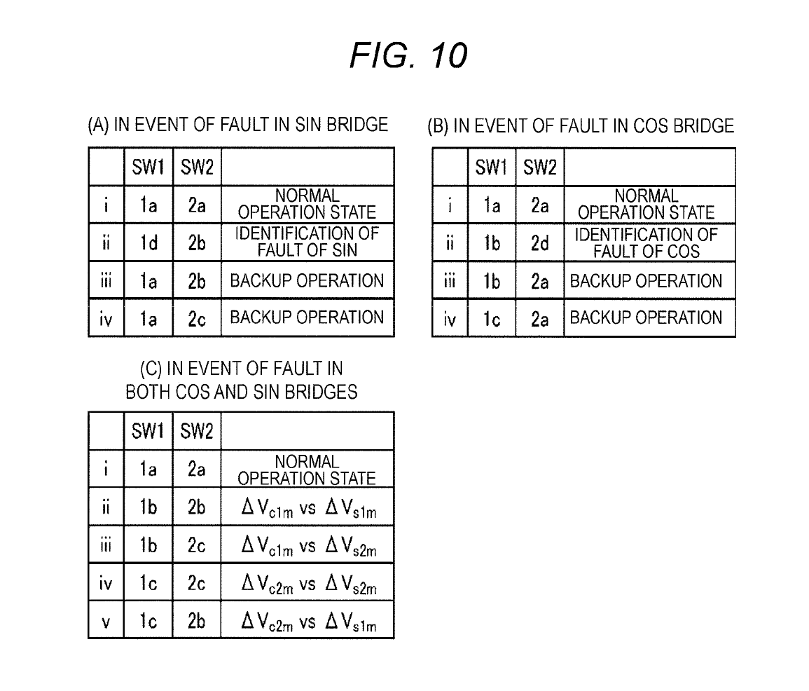

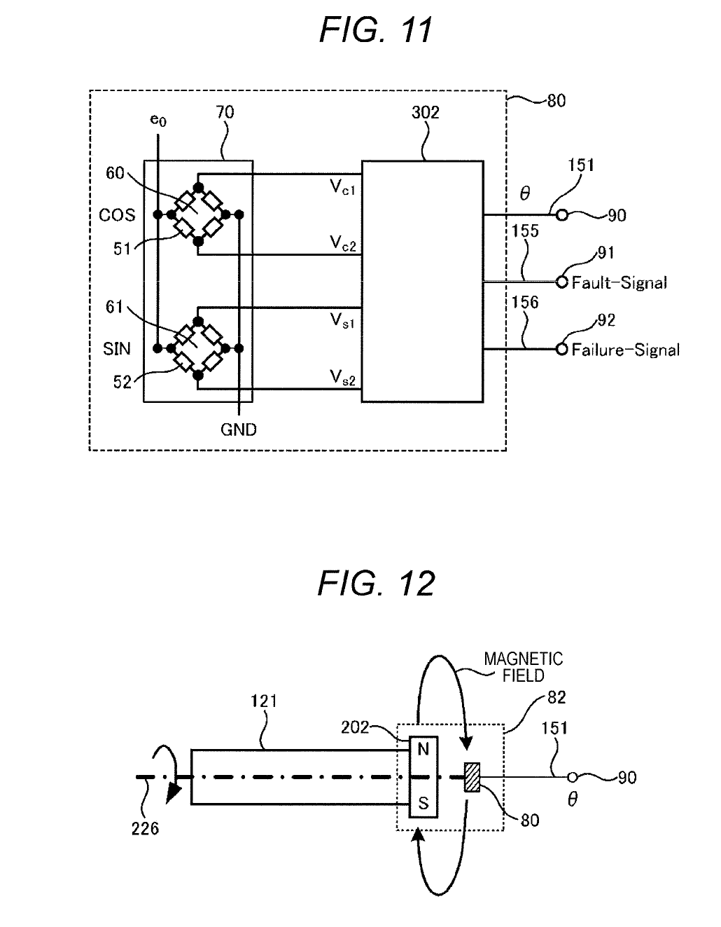

The magnetic field angle measurement apparatus 80 of a fourth embodiment using the invention will be described with reference to FIG. 11.

In the magnetic field angle measurement apparatus of this embodiment, the detection unit 302 outputs the magnetic field angle θ, and outputs a fault transmission signal 155 and a stop transmission signal 156 to the output terminals 91 and 92. The fault transmission signal 155 (Fault Signal) is a signal transmitting a state in which the occurrence of the fault is detected in the magnetic field angle measurement apparatus, but the correct angle θ is output by the operation of the backup operation mode.

Meanwhile, the stop transmission signal 156 (Failure Signal) is a signal notifying a state in which the correct angle is not output, that is, the function as the magnetic field angle measurement apparatus is stopped due to the serious fault degree in the magnetic field angle measurement apparatus. The case in which the stop transmission signal 156 is generated is, for example, a case in which the fault occurs in both two half bridges constituting the COS bridge 60.

In this embodiment, the fault in the magnetic field angle measurement apparatus is detected by the same method as that of the first embodiment, and the backup operation mode is performed. Then, the fault transmission signal 155 is generated during the operation in the backup operation mode.

In FIG. 11, the fault transmission signal 155 and the stop transmission signal 156 are output to different output terminals. The fault transmission signal 155 and the stop transmission signal 156 may be grouped in one signal line. As a specific method example of grouping the signals in one signal line, a method of transmitting two kinds of signal states by preparing a plurality of signal voltage levels or a method of outputting an error code corresponding to each of the fault transmission signal 155 and the stop transmission signal 156 using a digital signal may be exemplified.

Further, an angle output 151, the fault transmission signal 155, and the stop transmission signal 156 may be grouped in one signal line. Specifically, two kinds of error code signals which may be identified from the digital signal indicating the angle θ are determined in advance, and the error codes may be allocated to the fault transmission signal 155 and the stop transmission signal 156.

A specific example in which the fault transmission signal 155 and the angle output 151 are output to the same signal line will be described with reference to FIG. 19.

In this embodiment, the fault transmission signal and the angle output are output in the form of the digital data of a 16-bit length. The configuration of the digital data is illustrated in FIG. 19. In the data, the angle information 591 is included in the first bit to the twelfth bit, the flag of the stop transmission signal 592 is included in the fifteenth bit, and the flag of the fault transmission signal 593 is included in the sixteenth bit. The data of the data structure is output from the detection unit 302 of the magnetic field angle measurement apparatus 80. In this way, in the system which receives the data, it is possible to recognize whether the magnetic field angle measurement apparatus is operated in the normal mode or the backup operation mode together with the information of the magnetic field angle θ.

In this way, since the number of the output signal lines is decreased, the low-cost magnetic field angle measurement apparatus may be realized. Further, since the signal is output as the digital data, the noise resistance may be improved.

As illustrated in FIG. 19, since the angle signal 591 and the fault transmission signal 593 are provided as a set and the united data is output, there is an effect that the data receiving side may simultaneously recognize the measurement quality of the angle signal 591 and an appropriate process may be performed.

In this embodiment, the signal of the data structure of FIG. 19 is transmitted by a serial communication. The data of FIG. 19 may be transmitted in 1 μs if the transmission clock frequency of 16 MHz is used. In this way, the angle signal 591 and the fault transmission signal 593 may be transmitted substantially at the same time.

In this way, when the fault transmission signal is output, the operation state of the magnetic field angle measurement apparatus may be recognized in the upper-layer system equipped with the magnetic field angle measurement apparatus, and hence the action according to the operation state may be performed. The specific action is different in accordance with the system that uses the magnetic field angle measurement apparatus. However, an action may be performed which improves the safety by limiting the function or the performance of the system during, for example, the operation in the backup operation mode.

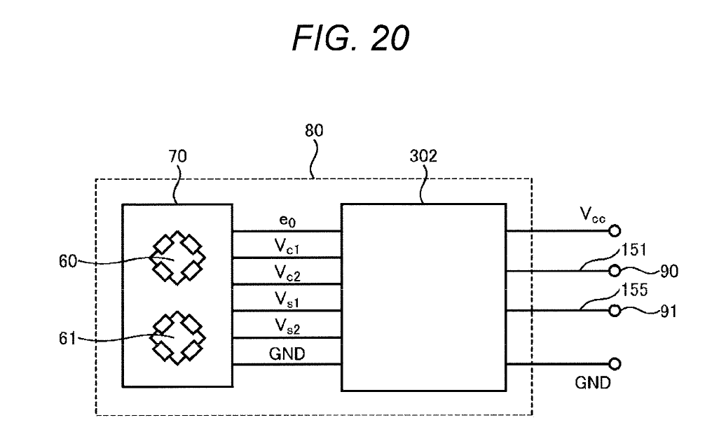

FIG. 20 is a diagram illustrating an example of the package configuration of the magnetic field angle measurement apparatus 80 with the configuration of FIG. 1 or the configuration of FIG. 11.

The COS bridge 60 and the SIN bridge 61 are received in the MR bridge unit 70. Six wirings are provided between the MR bridge unit 70 and the detection unit 302. Then, in this configuration, the excitation voltage e₀, the earth potential GND, and four half bridge output signals (V_{c1}, V_{c2}, Vₛ₁, and Vₛ₂) are provided. The output signal from the detection unit 302 includes the magnetic field angle output 151 and a fault transmission signal output 155. Furthermore, as illustrated in FIG. 19, the magnetic field angle output 151 and the fault transmission signal output 155 may be collected together in the form of the digital data and be output to one signal line. In addition, the detection unit 302 includes an earth potential terminal and a power supply voltage terminal (Vcc) for the power supplied from the outside.

The internal configuration of FIG. 20 has the configuration of FIG. 11.

In the configuration of FIG. 20, the MR bridge unit 70 and the detection unit 302 are respectively molded by a material such as a resin. In the package configuration, there is a case in which the wiring between the MR bridge and the detection unit 302 is disconnected due to a reason such as a stress or a residual stress in the molded portion.

In the configuration of the related art, when any one of four half bridge output signals is disconnected, the correct magnetic field angle is not output. On the contrary, in the configuration using the invention, when any one of four half bridge output signal is disconnected, the magnetic field angle is calculated by using the half bridge output signal which is not disconnected, and hence the correct magnetic field angle θ is output.

### Fifth Embodiment

A rotation angle measurement apparatus 82 as a fifth embodiment of the invention will be described with reference to FIG. 12.

The rotation angle measurement apparatus 82 includes a sensor magnet 202 as a magnetic flux generator and the magnetic field angle measurement apparatus 80. The sensor magnet 202 is provided in a rotation body 121, and the rotation body 121 rotates on a rotation center line 226.

Since the sensor magnet 202 is a magnetic flux generator, the sensor magnet generates the magnetic field in a direction indicated in FIG. 12. When the rotation body 121 rotates, the magnetic field direction at the position of the magnetic field angle measurement apparatus 80 also rotates. Thus, the rotation angle θr of the rotation body 121 may be measured by measuring the magnetic field angle.

The magnetic field angle measurement apparatus 80 used in this embodiment has the same configuration as that of the magnetic field angle measurement apparatus 80 of the first embodiment. Accordingly, even when the fault occurs in one of the half bridges of the magneto-resistance elements included in the rotation angle measurement apparatus 82, the correct rotation angle θr may be obtained although the measurement precision may be slightly degraded compared to the normal state. Thus, there is an effect that the function of the upper-layer system including the rotation angle measurement apparatus 82 may be continued.

### Sixth Embodiment

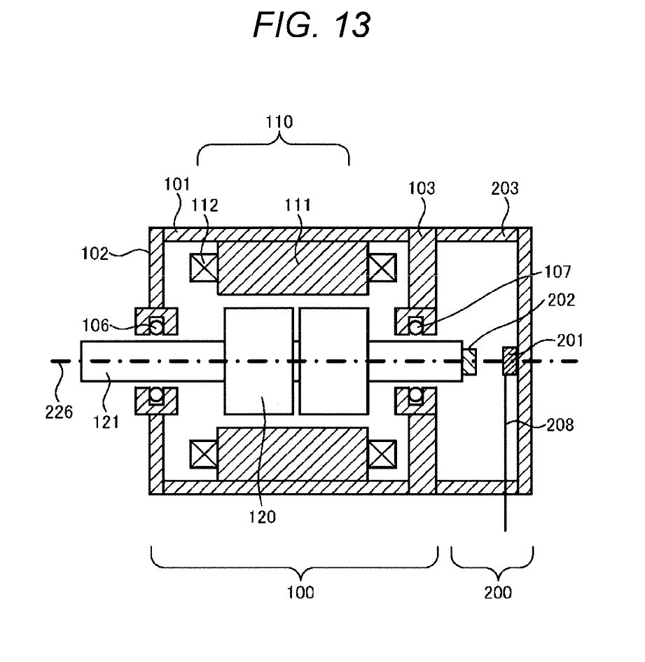

A rotation machine which uses a magnetic field angle measurement apparatus as a sixth embodiment of the invention will be described with reference to FIG. 13. Examples of the rotation machine include a motor and a generator, but the motor will be exemplified herein.

FIG. 13 illustrates a cross-sectional view of the rotation machine of this embodiment. This embodiment includes a motor 100 and a rotation angle detection unit 200.

The motor 100 is used to generate a rotational torque by causing a magnetic action between a plurality of fixed magnetic poles and a plurality of rotating magnetic poles to rotate the plurality of rotating magnetic poles, and includes a stator 110 which constitutes the plurality of fixed magnetic poles and a rotor 120 constituting the plurality of rotating magnetic poles. The stator 110 includes a stator core 111 and a stator coil 112 attached to the stator core 111. The rotor 120 is disposed at the inner peripheral side of the stator 110 so as to face the stator with a gap therebetween and is rotatably supported. In this embodiment, a three-phase AC surface magnet type synchronous motor is used as the motor 100.

A casing includes a cylindrical frame 101 and a first bracket 102 and a second bracket 103 which are provided at both axial ends of the frame 101. A bearing 106 is provided in the hollow portion of the first bracket 101, and a bearing 107 is provided in the hollow portion of the second bracket 103. These bearings rotatably support the rotation shaft 121.

A sealing component (not illustrated) is provided between the frame 101 and the first bracket 102. The sealing component is an O-ring which is formed in an annular shape, and is compressed while being interposed by the frame 101 and the first bracket 102 in the axial direction and the radial direction. Accordingly, the gap between the frame 101 and the first bracket 102 may be sealed, and hence the front side may be made to be waterproof. Further, a gap between the frame 101 and the second bracket 103 is also made to be waterproof by a seal member (not illustrated).

The stator 110 includes the stator core 111 and the stator coil 112 attached to the stator core 111, and is provided in the inner peripheral surface of the frame 101. The stator core 111 is a magnetic body (magnetic path forming body) which is formed by stacking a plurality of silicon steel plates in the axial direction, and includes an annular back core and a plurality of teeth which protrude from the inner peripheral portion of the back core inward in the radial direction and are arranged at the same interval in the circumferential direction.

A winding wire conductor constituting the stator coil 112 is concentratedly wound on each of the plurality of teeth. The plurality of winding wire conductors are electrically connected to the respective phases by the winding members arranged in parallel in the axial end of one coil end (near the second bracket 103) of the stator coil 112, and are electrically connected as a three-phase winding wire. As a method of connecting the three-phase winding wires, a Δ (delta) connection wiring method and a Y (star) connection wiring method are known. In this embodiment, a Δ (delta) connection wiring method is employed.

The rotor 120 includes a rotor core which is fixed onto the outer peripheral surface of the rotation shaft 121, a plurality of magnets which are fixed to the outer peripheral surface of the rotor core, and a magnet cover which is provided in the outer peripheral side of the magnet. The magnet cover is used to prevent the scattering of the magnet from the rotor core, and is a cylindrical member or a tubular member which is formed of a non-magnetic body of stainless steel (generally referred to as SUS).

Next, a configuration of the rotation angle detection unit 200 will be described.

The rotation angle detection unit 200 includes a magnetic field angle measurement apparatus 201 (hereinafter, referred to as the magnetic field sensor module 201) and a sensor magnet 202. The rotation angle detection unit 200 is provided in a space surrounded by a housing 203 and the second bracket 103. The sensor magnet 202 is provided in a shaft which rotates along with the rotation shaft 121, and when the rotation position of the rotation shaft 121 changes, the magnetic field direction changes. By detecting the magnetic field direction using the magnetic field sensor module 201, the rotation angle (rotation position) of the rotation shaft 121 may be measured.

When the magnetic field sensor module 201 is provided so that the MR bridge unit 70 of the magnetic field sensor module 201 is disposed on the rotation center line 226 of the rotation shaft 121, the distortion of the spatial distribution of the magnetic field generated by the sensor magnet 202 may be desirably decreased.

The sensor magnet 202 is a two-pole magnet which is magnetized as two poles, or a multi-pole magnet which is magnetized as four or more poles.

The magnetic field sensor module (magnetic field angle measurement apparatus) uses the magnetic field angle measurement apparatus 80 described in the fourth embodiment of the invention.

The magnetic field sensor module 201 is provided in the housing 203. It is desirable that the housing 203 be formed of a material such as aluminum or a resin of which the absolute value of the magnetic susceptibility is 0.1 or less so as not to influence the magnetic flux direction. In this embodiment, a resin is used.

Furthermore, the magnetic field sensor module 201 may be fixed in reference to the motor. The magnetic field sensor module 201 may be fixed to the component other than the housing 203. When the magnetic field sensor module is fixed in reference to the motor, the rotation angle of the rotation shaft 121 may be detected by detecting a change in the magnetic field direction of the magnetic field sensor 201 when the direction of the sensor magnet 202 changes with a change in the rotation angle of the rotation shaft 121.

A sensor wiring 208 is connected to the magnetic field sensor module 201. The output signal of the magnetic field sensor 201 is transmitted by the sensor wiring 208.

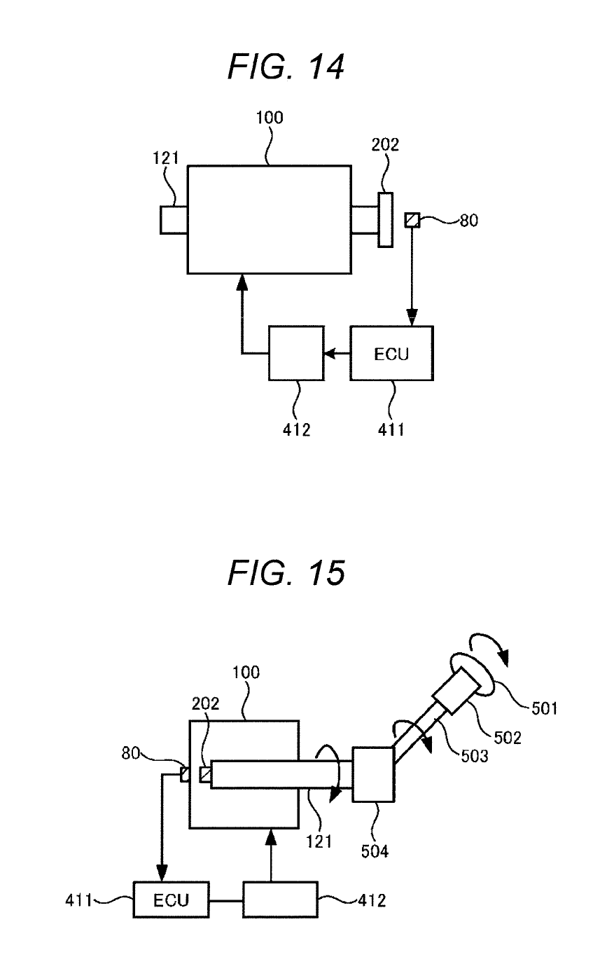

Next, a configuration of controlling the rotation machine of this embodiment will be described with reference to FIG. 14.

The output signal of the magnetic field angle measurement apparatus 80 is input to the rotation machine controller (rotation machine control ECU) 411. The signal input to the rotation machine controller includes three kinds of signals, that is, the magnetic field angle (rotation angle) θ, the fault transmission signal, and the stop transmission signal. These three kinds of signals may be individually transmitted through three signal lines. Alternatively, as described above, the signals may be transmitted by time-division through one signal line, for example, in the form of the digital signal.

Further, when the fault transmission signal is not used in the rotation machine controller, the signal input to the rotation machine controller may be only the signal of the rotation angle θ.

The rotation machine controller calculates an appropriate drive voltage to be given to the rotation machine based on the input rotation angle θ, outputs a signal to a rotation machine drive unit 412, and drives the rotation machine 100 by the drive waveform output from the rotation machine drive unit 412.

Although there are various rotation machine control methods in the rotation machine controller, a vector control method is used in this embodiment.

According to this embodiment, even when the fault occurs in the half bridge of a part of the MR bridge unit 70 constituting the magnetic field angle measurement apparatus 80, the backup operation mode is performed, and the correct angle is input to the rotation machine controller. Accordingly, there is an effect that the function operation of the rotation machine may be continuously performed.

Further, the fault transmission signal is input to the rotation machine controller in the backup operation mode. In this case, the rotation machine controller transmits the fault transmission signal to the upper-layer system provided in the rotation machine. In the upper-layer system, it is possible to perform an appropriate action in which the function of the system is limited based on the fault transmission signal transmitted from the rotation machine.

Furthermore, in FIG. 14, the MR bridge unit 70 and the detection unit 302 are disposed inside the magnetic field angle measurement apparatus 80 so as to be disposed near the sensor magnet 202. However, this embodiment is not limited thereto. As anoother configuration example, the signal processing unit 303 inside the detection unit 302 may be disposed near the rotation machine controller. Alternatively, the signal processing unit 303 may be provided inside the rotation machine controller.

In a case where the signal processing unit 303 is configured as the microcontroller, the number of the microcontrollers in use may be decreased by providing the function of the signal processing unit 303 in the rotation machine controller, and hence there is an effect that the low-cost rotation machine may be realized.

Furthermore, in the description of FIGS. 13 and 14, the motor is exemplified as the rotation machine. In this specification, the “rotation machine” includes not only the motor but also a “generator”, that is, a machine for converting mechanical energy into electrical energy. Even in the case of the generator, the effect of the invention may be obtained by the same configuration as that of FIG. 13 or 14.

### Seventh Embodiment

An example of an electric power-assisted steering (referred to as an EPS) as a seventh embodiment of the invention is illustrated in FIG. 15.

Rotational movement of a steering shaft 503 which is mechanically connected to a steering wheel 501 is linked with the movement of a rotation shaft 121 through a joint unit 504, which is composed of a gear. The rotation shaft 121 is a rotation shaft of the motor 100, and one end thereof is provided with the sensor magnet 202. The magnetic field angle measurement apparatus 80 (hereinafter, referred to as the magnetic field sensor module 201) is provided near the sensor magnet 202, and measures the rotation angle of the rotation shaft 121 and transmits the result to an ECU 411. The ECU 411 calculates an appropriate motor drive amount from a signal from a torque sensor (not illustrated) provided inside a steering column 502 and the rotation angle signal θ from the magnetic field sensor module 201, and transmits the result to the motor drive unit 412. Accordingly, the motor 100 assists the motion of the steering shaft 503 through the rotation shaft 121.

In this embodiment, the magnetic field angle measurement apparatus described in the fourth embodiment of the invention is used in the magnetic field angle measurement apparatus 80. Accordingly, since the correct magnetic field angle (rotation angle) is output even when the fault occurs in the half bridge of the MR bridge, there is an effect that the function of the electric power steering may be continuously performed.

This is a particularly important function in a steer-by-wire system without a mechanical backup or a hydraulic system.

### Eighth Embodiment

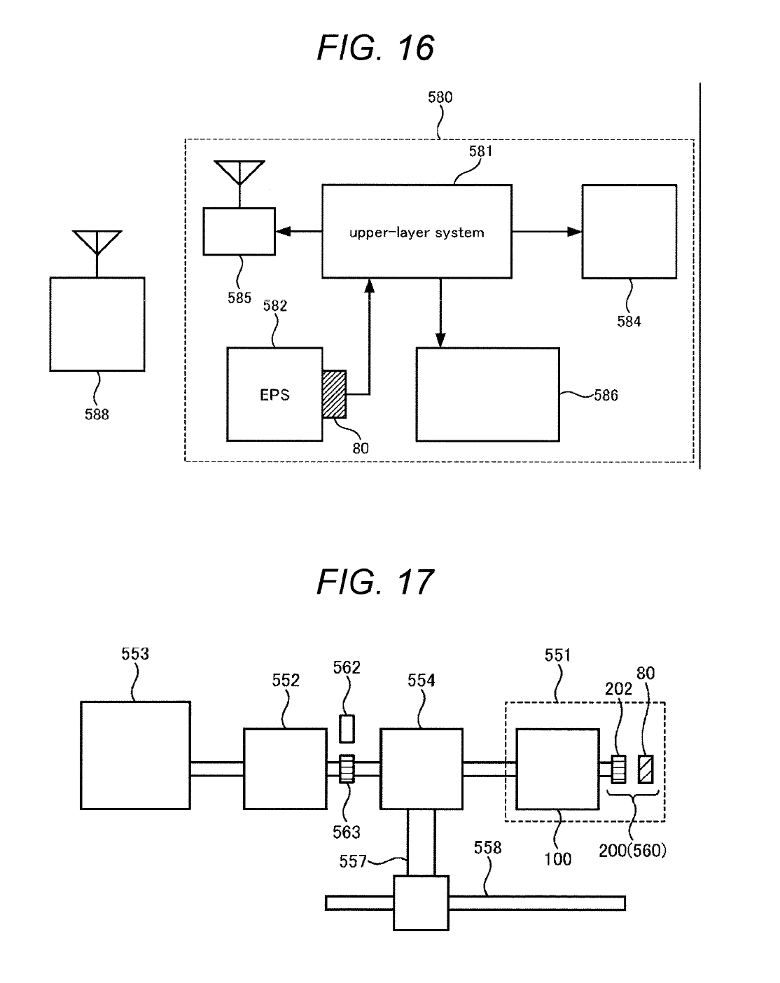

A vehicle 580 as an eighth embodiment using the invention will be described with reference to FIG. 16.

In this embodiment, the vehicle 580 which uses the electric power steering system is provided. The magnetic field angle measurement apparatus 80 which is used in the electric power steering is the rotation angle measurement apparatus of the fourth embodiment of the invention.

When the fault occurs in the magnetic field angle measurement apparatus 80, the backup operation mode is performed according to the type of fault, and the fault transmission signal is generated. Alternatively, in a case of the fault which may not enable the backup operation mode, the stop transmission signal is generated.

The stop transmission signal is transmitted to an upper-layer system 581 of an electric power steering system (EPS system) 582. Alternatively, the signal may be transmitted to the upper-layer system 581 through an electronic control unit (ECU) of the electric power steering system (EPS system) 582. Alternatively, although not illustrated in FIG. 16, the signal may be transmitted to the upper-layer system 581 through a system and a layer other than the EPS system 582.

When the fault transmission signal is transmitted to the upper-layer system 581, the upper-layer system 581 performs all the following operations or several combinations of the operations.

First, the fault is displayed on a display system 584 of a driver seat or the occurrence of the fault is notified to the driver through a sound such as an alarm bell. In this way, the vehicle 580 may be operated, but the driver gets a request of visiting a vehicle repair station or the like as soon as possible.

Second, the upper-layer system 581 performs a function limitation mode. In the function limitation mode, a safety level is improved through a limitation in function, such as a limitation in the maximum speed of the vehicle 580. The function limitation mode may also provide an operation necessary for moving to the repair station. In this embodiment, the maximum speed is limited by limiting the function of the vehicle drive system 586.

Third, the upper-layer system 581 transmits the occurrence of the fault to a vehicle repair station 588 by using a wireless sending system 585. Accordingly, the vehicle repair station 588 may promptly repair the corresponding vehicle when the vehicle visits the vehicle repair station. Further, when the corresponding vehicle does not visit the vehicle repair station even after a predetermined period elapses, the vehicle owner may frequently get a repair request.

In this way, according to the vehicle 580 of this embodiment, when the fault occurs in the magnetic field angle measurement apparatus 80 and the backup operation mode is performed, the function for the movement to the vehicle repair station is provided, and the function or the performance related to the maximum speed is limited, thereby improving the safety. Further, when the occurrence of the fault is transmitted to a plurality of corresponding persons of the repair station or the driver and a plurality of systems, there is an effect that the repair of the fault may be urged promptly.

### Ninth Embodiment

A ninth embodiment of the invention will be described with reference to FIG. 17. This embodiment relates to an example of a hybrid vehicle drive apparatus using the rotation angle measurement apparatus.

FIG. 17 is a schematic diagram of a hybrid vehicle drive apparatus which is obtained by the combination of an electric motor and an internal combustion engine as the power of an automobile. The output rotation shaft of the engine 553, the generator 552, and the drive motor 551 are coaxially disposed, and respectively transmit appropriate power by the function of a power distribution mechanism 554. A power distribution method is appropriately set based on information on a vehicle running state, an acceleration instruction state, and a battery charging state. Further, a power combination mechanism 557 is provided so as to transmit power from the power distribution mechanism 554 to a power shaft 558.

In the drive motor 551, the rotation machine described in the sixth embodiment of the invention is used. The drive motor 551 includes the motor 100 and the rotation angle detection unit 200 as described in the sixth embodiment. The rotation angle detection unit 200 constitutes a drive motor rotation angle sensor 560 which detects the rotation angle of the drive motor 551.

The generator 552 is provided with a generator rotation angle sensor 562. The rotation shaft of the generator is provided with the sensor magnet 563, and the direction of the magnetic field generated by the sensor magnet 563 is measured by the generator rotation angle sensor 562. In the generator rotation angle sensor 562, the magnetic field angle measurement apparatus described in the first embodiment is used.

According to the configuration of this embodiment, since the correct rotation angle θ is output by using the normal half bridge when the fault occurs in the MR bridge unit 70 of the rotation angle measurement apparatus 82, an operation in the backup operation mode may be performed. Accordingly, there is an effect that the stop of the entire vehicle may be prevented.

Further, in this embodiment, it is further desirable to transmit the fault transmission signal to the upper-layer system when the fault occurs in the drive motor or the generator rotation angle sensor 562 and the backup operation mode is performed.

When the upper-layer system receives the fault transmission signal, the safety is ensured by performing an action in which the maximum speed of the vehicle is limited. Further, there is an effect that an action such as a repair may be promptly performed by generating an alarm for notifying the fault state to the driver or notifying the fault through the communication with the vehicle repair station.

Further, it is also useful to limit the regenerative brake function using the generator as the limitation of the function in the event of the fault. When the generator rotation angle sensor becomes a backup mode, the regenerative brake function using the generator is stopped, and the brake function is performed by the mechanical brake using the hydraulic system or the like. In this way, there is an effect that the safety may be ensured without causing a dangerous state such as an insufficient brake state caused by the malfunction of the generator.

### Tenth Embodiment

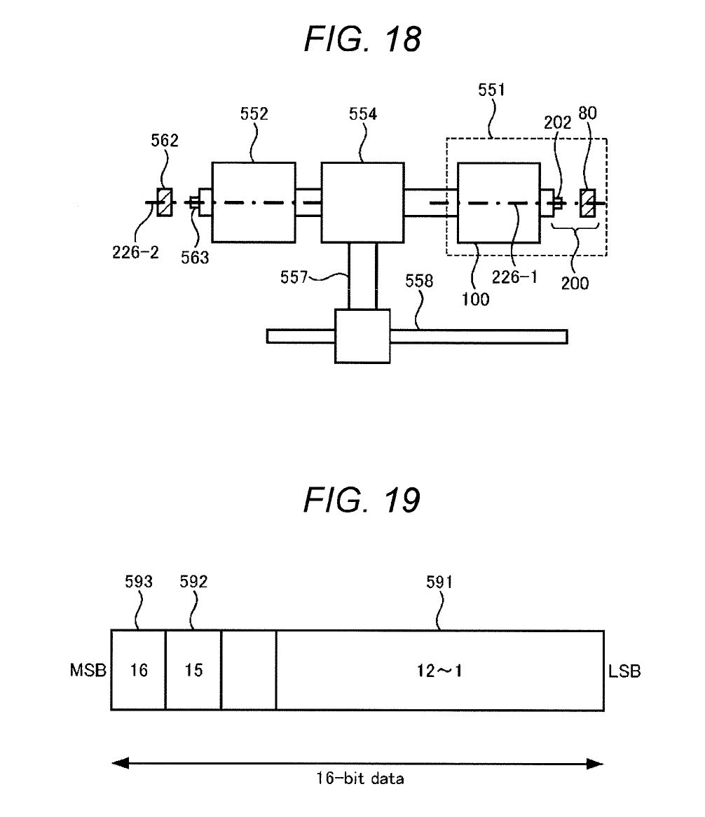

In the above-described embodiment, the hybrid vehicle drive apparatus is exampled, but an example of an electric vehicle drive apparatus as a tenth embodiment of the invention will be described with reference to FIG. 18.

FIG. 18 is a schematic diagram of an electric vehicle drive apparatus which uses a power electric motor of a vehicle. The drive motor 551 and the generator 552 are coaxially provided, and respectively transmit appropriate power by the function of the power distribution mechanism 554. The power distribution method is appropriately set based on information on a vehicle running state, an acceleration instruction state, and a battery charging state.

In the drive motor 511, the rotation machine described in the sixth embodiment of the invention is used. As described in the sixth embodiment, the drive motor 511 includes the motor 100 and the rotation angle detection unit 200.

The generator 552 is provided with the generator rotation angle sensor 562. The rotation shaft of the generator is provided with the sensor magnet 563, and the direction of the magnetic field generated by the sensor magnet 563 is measured by the generator rotation angle sensor 562. In the generator rotation angle sensor 562, the magnetic field angle measurement apparatus described in the first embodiment is used.

According to the configuration of this embodiment, since the correct rotation angle θ is output by using the normal half bridge when the fault occurs in the MR bridge unit 70 of the rotation angle measurement apparatus 82, an operation in the backup operation mode may be performed. Accordingly, there is an effect that the stop of the entire vehicle may be prevented.

Since the vehicle is completely stopped when the drive motor of the electric vehicle terminates its function, the effect of the invention is particularly effective.

As described above, an example of using the GMR element as the magneto-resistance element of the MR bridge unit 70 has been described.

The invention is not limited to the GMR element, but may be also applied to a magneto-resistance element. Here, an example of using an anisotropic magneto-resistance element (AMR element) will be described.

In the AMR element, when the angle α (hereinafter, referred to as the current direction a) indicating the current flow direction and the magnetic field angle θₘ are defined, the resistance value of the element changes in accordance with the following equation.

[Expression 21]

R=R₀+ΔR cos²(θₘ−α)=R₀+ΔR cos²(θ) Expression 21

Here, in the final equation, the reference angle of the magnetic field angle θ is set equal to the current direction α. Furthermore, the current direction a may be set in accordance with the wiring pattern shape.

In the COS bridge 60 of FIG. 4, the current directions of the MR elements R₁ and R₃ are set as α=0 and the current directions of the MR elements R₄ and R₂ are set as α=90°. Then, the signal voltage ΔV_{c21}=V_{c2}−V_{c1} is set as below.

[Expression 22]

$$Δ {V}_{C 21} = Acos ( 2 θ ) \\ A = \frac{{e}_{0} Δ R}{2 {R}_{0} Δ R} \qquad Expression 22$$

In the SIN bridge 61 of FIG. 4, the current directions of the MR elements R₁ and R₃ are set as α=45° and the current directions of the MR elements R₄ and R₂ are set as α=135°. Then, the signal voltage ΔVₛ₂₁=Vₛ₂−Vₛ₁ is set as below.

[Expression 23]

ΔV_{S21}=Δ sin(2θ) Expression 23

[Expression 24]

2θ=a tan 2(ΔVₛ₂₁,ΔVₒ₂₁) Expression 24

Thus, the magnetic field angle θ is obtained.

Here, the effective magnetic field angle θ_{eff} is defined as θ_{eff}=20. Then, in the signal output of the bridge circuit including the AMR element, the COS bridge 60 is proportional to cos(θ_{eff}), and the SIN bridge 61 is proportional to sin(θ_{eff}).

In this way, in the magnetic field angle measurement apparatus using the AMR element, the effective magnetic field angle θ_{eff}=2θ is defined, the bridge for outputting a signal proportional to cosine cos(θ_{eff})) of the effective magnetic field angle θ_{eff} is defined by the COS bridge 60, and the bridge for outputting a signal proportional to sine sin (θ_{eff}) of the effective magnetic field angle θ_{eff} is defined by the SIN bridge 61. At this time, the reference angle of the magnetic field angle is appropriately selected so that two signals are proportional to cos(θ_{eft}) and sin(θ_{eff}).

That is, (Equation 8) and (Equation 9) of the bridge circuit of the GMR element substantially correspond to each other.

Next, the following equation is obtained when the differential voltage between the middle voltage Vₘ=e₀/2 and the signal voltage of each half bridge is obtained.

[Expression 25]

ΔV_{C1m}−−2(V_{C1}−Vₘ)=A cos(2θ)

ΔV_{C2m}−+2(V_{C2}−Vₘ)=A cos(2θ)

ΔV_{S1m}−−2(V_{S2}−Vₘ)=A sin(2

ΔV_{S2m}−+2(V_{S2}−Vₘ)=A sin(2θ) Expression 25

### Equation 25

This corresponds to (Equation 16).

Here, a case in which the fault occurs in the SIN bridge 61 will be supposed. In this case, the magnetic field angle θ is obtained by using the signal ΔVₛⱼₘ (j=1 or 2) of the normal half bridge.

[Expression 26]

2θ=a tan 2(ΔVₛⱼₘ,ΔV_{c21}) Expression 26

The magnetic angle is obtained as above.

Next, a process of specifically identifying the normal half bridge will be described in detail. Since the relation equation of “(cos θ_{eff})²+(sin θ_{eff})²=1” is established, the residual amount is defined by the following equation:

[Expression 27]

Δ_{Res}(j)=A²−{(ΔV_{C21})²+(ΔV_{Sjm})2} Expression 27

Thus, (j=1 or 2) is calculated, and it is possible to identify the half bridge of the threshold value or less as the normal half bridge.

Thus, it is obvious that the above-described embodiments using the GMR element are effective when using the AMR element.

### REFERENCE SIGNS LIST

51, 52 GMR element
23 loss portion
60 COS bridge
61 SIN bridge
65 half bridge
70 MR bridge unit
71, 72 half bridge output terminal
80 magnetic field angle measurement apparatus
82 rotation angle measurement apparatus
100 motor
110 stator
111 stator core
112 stator coil
120 rotor
121 rotation body
151 angle output
155 fault transmission signal
156 stop transmission signal
200 rotation angle detection unit
202 sensor magnet
226 rotation center line
260 wafer
262 wafer pad
265 sensor element package
302 detection unit
303 signal processing unit
311 redundant unit
313 selection switch
331 resistance
411 electronic control unit
412 drive unit
501 steering wheel
502 steering column
503 steering shaft
504 joint unit
551 drive motor
552 generator
553 engine
554 power distribution mechanism
557 power combination mechanism
558 power shaft
560 drive motor rotation angle sensor
562 generator magnetic field angle sensor
563 sensor magnet
580 vehicle
581 upper-layer system
582 EPS system
583 vehicle drive system
584 driver seat display system
585 wireless sending system
588 vehicle repair station
591 angle information data
592 stop signal data
593 fault signal data

All publications, patents, and patent applications cited in this specification are incorporated in this specification as a reference.

1. A magnetic field angle measurement apparatus comprising:
a COS bridge and a SIN bridge each of which includes a magneto-resistance element; and
a detection unit,
wherein the detection unit outputs an angle signal based on a signal output from a normal half bridge when a fault occurs in any one of respective half bridges of the COS bridge or the SIN bridge.

2. The magnetic field angle measurement apparatus according to claim 1, further comprising:
a unit for identifying the normal half bridge.

3. The magnetic field angle measurement apparatus according to claim 2,
wherein the detection unit outputs a fault transmission signal when outputting an angle signal based on the signal output from the normal half bridge.

4. The magnetic field angle measurement apparatus according to claim 3,
wherein a stop transmission signal is provided in addition to the fault transmission signal.

5. The magnetic field angle measurement apparatus according to claim 3,
wherein the fault transmission signal is output as a digital signal by using the same signal line as that of the angle signal.

6. A rotation angle measurement apparatus comprising:
a magnetic flux generator which is attached to a rotation body; and
the magnetic field angle measurement apparatus according to claim 1,
wherein the rotation angle of the rotation body is measured by measuring a direction of a magnetic field generated by the magnetic flux generator.

7. A rotation machine comprising:
a rotor;
a stator;
a magnetic flux generator which rotates along with the rotor; and
the magnetic field angle measurement apparatus according to claim 1,
wherein a direction of a magnetic field generated by the magnetic flux generator is measured by the magnetic field angle measurement apparatus.

8. A system equipped with the magnetic field angle measurement apparatus according to claim 3,
wherein the system includes a normal operation mode and a function limitation mode,
a part of a function of the system is limited in the function limitation mode, and
the function limitation mode is performed when the magnetic field angle measurement apparatus outputs the fault transmission signal.

9. A vehicle which uses the magnetic field angle measurement apparatus according to claim 3,
wherein the vehicle includes a normal operation mode and a function limitation mode, and
the function limitation mode is performed when the magnetic field angle measurement apparatus outputs the fault transmission signal.

10. The vehicle according to claim 9,
wherein a maximum speed of the vehicle in the function limitation mode is lower than a maximum speed in the normal operation mode.

11. A vehicle drive apparatus comprising:
the rotation machine according to claim 7.

12. A vehicle drive apparatus comprising:
the rotation machine according to claim 7 serving as a motor,
wherein the detection unit outputs a fault transmission signal when the magnetic field angle measurement apparatus outputs an angle signal based on a signal output from the normal half bridge, and a maximum speed of the motor is limited when the fault transmission signal is output.

13. A vehicle drive apparatus comprising:
a generator; and
a motor,
wherein the generator is provided with the magnetic field angle measurement apparatus according to claim 3, and
when the magnetic field angle measurement apparatus outputs the fault transmission signal, a regenerative brake function using the generator is limited.

14. The magnetic field angle measurement apparatus according to claim 1,
wherein the magneto-resistance element is a giant magneto-resistance element.

15. The magnetic field angle measurement apparatus according to claim 1,
wherein the magneto-resistance element is an anisotropic magneto-resistance element.

16. The magnetic field angle measurement apparatus according to claim 1,
wherein the detection unit includes a differential detector for an output signal of the half bridge and a middle voltage as ½ of an excitation voltage to the half bridge.

17. The magnetic field angle measurement apparatus according to claim 1,
wherein the fault is a disconnection between one of the half bridges and the detection unit.

18. The magnetic field angle measurement apparatus according to claim 2,
wherein, when the angle signal is output based on the signal output from the normal half bridge, the detection unit outputs the fault transmission signal.

19. The magnetic field angle measurement apparatus according to claim 18,
wherein a stop transmission signal is provided in addition to the fault transmission signal.

20. The magnetic field angle measurement apparatus according to claim 18,
wherein the fault transmission signal is output as a digital signal by using the same signal line as that of the angle signal.

21. The magnetic field angle measurement apparatus according to claim 16,
wherein the middle voltage is generated by a ratiometric circuit from the excitation voltage.

22. A method of calculating an angle of a magnetic field angle measurement apparatus including a COS bridge and a SIN bridge each of which includes a magneto-resistance element and a detection unit,
wherein the detection unit calculates an angle signal based on a signal output from a normal half bridge when a fault occurs in any one of respective half bridges of the COS bridge or the SIN bridge.
